(19) United States
(12) Patent Application Publication
(10) Pub. No.: US 2024/0275507 A1
(43) Pub. Date: Aug. 15, 2024

(54) WIRELESS COMMUNICATION DEVICE AND WIRELESS COMMUNICATION METHOD

(71) Applicant: SONY GROUP CORPORATION, TOKYO (JP)

(72) Inventors: YUSUKE TANAKA, TOKYO (JP); RYUICHI HIRATA, TOKYO (JP); KEN TANAKA, TOKYO (JP); KOSUKE AIO, TOKYO (JP)

(21) Appl. No.: 18/257,308

(22) PCT Filed: Dec. 10, 2021
(86) PCT No.: PCT/JP2021/045490

§ 371 Date: Jun. 14, 2023

(30) Foreign Application Priority Data
Dec. 25, 2020 (JP) 2020-216292

(51) Int. Cl. H04B 17/345

(52) U.S. Cl. CPC H04B 17/345

(57) ABSTRACT

The present technique relates to a wireless communication device and a wireless communication method that enable a proper communication setting. A wireless communication device according to an aspect of the present technique includes a control unit configured to: transmit an inter-link interference measurement signal by using a first channel from a first antenna or a second antenna that forms a first link from among a plurality of antennas of a communication unit that communicates with an external communication device through a plurality of links, and measure interference caused by the inter-link interference measurement signal, by using a third antenna or a fourth antenna that forms a second link from among the plurality of antennas.

### TECHNICAL FIELD

The present technique relates to a wireless communication device and a wireless communication method and particularly relates to a communication device and a communication method that enable a proper communication setting.

### BACKGROUND ART

Methods for use cases that require high transmission rates, e.g., next-generation XR (X reality) include a Multi-Link Operation (MLO) that is available as wireless communications using multiple links. It is assumed that a terminal for the MLO has a plurality of antennas or RF circuits for respective links.

However, the plurality of antennas or RF circuits for the respective links may be insufficiently separated because of restrictions on the sizes of terminals and modules. In this case, inter-link interference may occur such that out-of-band power leaks from one link to another.

The amount of inter-link interference changes according to a channel used for actual communications, communication parameters such as a bandwidth and transmitted power, and individual differences such as device variations among terminals. Thus, the amount of inter-link interference is hard to determine in the design and fabrication stages of the terminals.

In communications for sensing carriers, in particular, carrier sensing is disabled when the amount of inter-link interference exceeds a detection threshold value.

### CITATION LIST

### Patent Literature

### [PTL 1]

Japanese Translation of PCT Application No. 2015-505651

### SUMMARY

### Technical Problem

In a terminal for an MLO, communications using MIMO (Multiple Input Multiple Output) require measurement of inter-link interference occurring during actual communications and a proper setting of communications.

The present technique is contrived in view of such circumstances and is configured to make a proper setting of communications.

### Solution to Problem

A wireless communication device according to an aspect of the present technique includes a control unit configured to cause an inter-link interference measurement signal to be transmitted by using a first channel from a first antenna or a second antenna that forms a first link from among a plurality of antennas of a communication unit that communicates with an external communication device through a plurality of links, and measure interference caused by the inter-link interference measurement signal, by using a third antenna or a fourth antenna that forms a second link from among the plurality of antennas.

According to an aspect of the present technique, control is performed to: transmit an inter-link interference measurement signal by using a predetermined channel from a first antenna or a second antenna that forms a first link from among a plurality of antennas of a communication unit that communicates with an external communication device through a plurality of links, and measure interference caused by the inter-link interference measurement signal, by using a third antenna or a fourth antenna that forms a second link from among the plurality of antennas.

### BRIEF DESCRIPTION OF DRAWING

FIG. 1 illustrates a configuration example of a communication system of the present technique.

FIG. 2 illustrates a configuration example of a wireless communication device.

FIG. 3 is a sequence diagram showing operations in a first embodiment of the present technique.

FIG. 4 illustrates measuring operation sequence 1 of inter-link interference in the present technique.

FIG. 5 illustrates a configuration example of a signal for measuring inter-link interference in the present technique.

FIG. 6 illustrates measuring operation sequence 2 of inter-link interference in the present technique.

FIG. 7 illustrates measuring operation sequence 3 of inter-link interference in the present technique.

FIG. 8 is a flowchart showing operations in the first embodiment of the present technique.

FIG. 9 is a sequence diagram showing operations in a second embodiment of the present technique.

FIG. 10 is a flowchart showing operations in the second embodiment of the present technique.

FIG. 11 is a sequence diagram showing other operations in the second embodiment of the present technique.

FIG. 12 is a flowchart showing other operations in the second embodiment of the present technique.

### DESCRIPTION OF EMBODIMENTS

Embodiments for implementing the present technique will be described below. The description will be made in the following order.
1. <Configuration Example of Communication System>
2. First Embodiment, Operation Example of AP MLD
3. Second Embodiment, Operation Example of Non-AP MLD
3-1. Operation Example of Non-AP MLD performing Active Scan
3-2. Operation Example of Non-AP MLD performing Passive Scan
4. Others

### 1. Configuration Example of Communication System

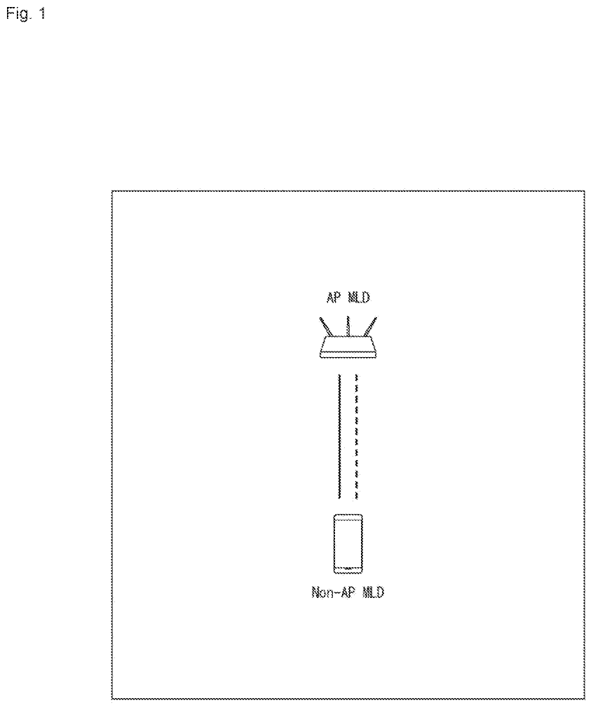

FIG. 1 illustrates a configuration example of a communication system of the present technique. The communication system in FIG. 1 is configured with an Access Point Multi Link Device (AP MLD) and a Non-AP MLD. The AP MLD is a wireless communication device that has a function equivalent to a base station accommodating an MLO. The Non-AP MLD is a wireless communication device that has a function equivalent to a terminal accommodating an MLO.

The Non-AP MLD is connected to the AP MLD. A solid line and a dashed line that connect the AP MLD and the Non-AP MLD represent connections via different links. When the AP MLD and the Non-AP MLD do not need to be distinguished from each other, the AP MLD and the Non-AP MLD will also be simply referred to as MLDs.

Note that a “link” in the present specification refers to a wireless transmission path that enables data transmission between two communication devices.

Each link is selected from, for example, a plurality of wireless transmission paths (channels) that are divided for respective frequency bands and are mutually independent from one another. For example, channels used as links are selected from a plurality of channels included in any one of frequency bands such as a 2.4 GHz band, a 5 GHz band, a 6 GHz band, and a 920 MHz band.

The two links used in the communication system illustrated in FIG. 1 may be two channels selected from the same frequency band or two channels selected from different frequency bands. In addition, the number of links used between the AP MLD and the Non-AP MLD is not limited to two and three or more links may be used.

In the present technique, before the start of communications using a plurality of links, the degree of interference of communications of one link with the other link can be measured on the AP MLD side or the Non-AP MLD side and a proper communication setting can be made on the basis of a measured interference amount.

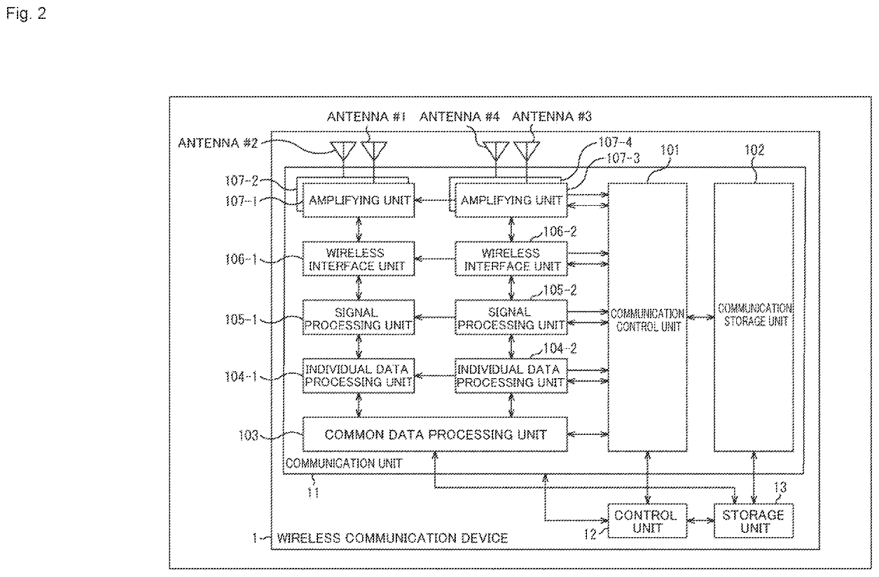

FIG. 2 is a block diagram illustrating a configuration example of a wireless communication device.

A wireless communication device 1 is a wireless communication device that operates as an AP MLD or a Non-AP MLD. The AP MLD and the Non-AP MLD have the same configuration.

The wireless communication device 1 includes a communication unit 11, a control unit 12, a storage unit 13, an antenna #1, an antenna #2, an antenna #3, and an antenna #4.

The communication unit 11 is configured to include a communication control unit 101, a communication storage unit 102, a common data processing unit 103, individual data processing units 104-1 and 104-2, signal processing units 105-1 and 105-2, wireless interface units 106-1 and 106-2, and amplifying units 107-1 to 107-4.

The communication unit 11 transmits and receives information by radio communications via the antenna #1, the antenna #2, the antenna #3, and the antenna #4.

If it is not necessary to identify the individual data processing units 104-1 and 104-2, the signal processing units 105-1 and 105-2, the wireless interface units 106-1 and 106-2, and the amplifying units 107-1 to 107-4, the units are collectively referred to as the individual data processing unit 104, the signal processing unit 105, the wireless interface unit 106, and the amplifying unit 107.

The communication control unit 101 controls an operation of each unit and information transmission between the units. The communication control unit 101 performs control to transfer, to the data processing units, control information and management information to be notified to other communication devices.

For example, the communication control unit 101 controls the units so as to transmit a frame for measuring inter-link interference, measure inter-link interference, and make a setting/change based on a combination of antennas and the inter-link interference of a communication system to be used.

The communication storage unit 102 holds information to be used by the communication control unit 101. In addition, the communication storage unit 102 holds data to be transmitted and received data.

During transmission, the common data processing unit 103 performs sequence management of data held in the communication storage unit 102 and control information and management information that are received from the communication control unit 101. The common data processing unit 103 generates data units by performing encryption or the like and allocates the data units to the individual data processing units 104. The common data processing unit 103 generates, for example, the data unit of an inter-link interference measurement signal, which will be described later. According to the allocation by the common data processing unit 103, the data units are supplied to the individual data processing units 104.

During reception, the common data processing unit 103 performs deciphering and reordering of the data units supplied from the individual data processing units 104. Data obtained by deciphering or the like of the data units is properly supplied to the control unit 12 and the storage unit 13.

During transmission, the individual data processing unit 104 performs a channel access operation based on carrier sensing. Moreover, the individual data processing unit 104 adds a MAC (Media Access Control) header and an error-detecting code to data to be transmitted, and connects a plurality of data units supplied from the common data processing unit 103. The data units obtained by connection or the like is supplied to the signal processing units 105.

During reception, the individual data processing units 104 disconnects the MAC header of the data unit supplied from the signal processing unit 105, analyzes the data unit, detects an error of the data unit, and requests resending of the data unit. The data units having been subjected to the processing by the individual data processing units 104 are supplied to the common data processing unit 103.

The operations performed by the common data processing unit 103 and the individual data processing unit 104 are not limited to the foregoing operations. For example, at least some of operations performed by the common data processing unit 103 may be performed by the individual data processing unit 104, or at least some of operations performed by the individual data processing unit 104 may be performed by the common data processing unit 103. The common data processing unit 103 and the individual data processing units 104 constitute a data processing unit.

During transmission, the signal processing unit 105 performs encoding, interleaving, and modulation or the like on the data unit supplied from the individual data processing unit 104 and generates a symbol stream by adding a physical header. The symbol stream generated by the signal processing unit 105 is supplied to the wireless interface unit 106. Data may be transmitted for each antenna by using a certain delay amount and a cyclic shift delay (CSD) without space separation.

During reception, the signal processing unit 105 analyzes the physical header, performs demodulation, deinterleaving, and decoding or the like on the symbol stream supplied from the wireless interface unit 106, and generates the data unit. Moreover, the signal processing unit 105 estimates a complex channel characteristic and performs space separation as necessary. The data unit generated by the signal processing unit 105 is supplied to the individual data processing unit 104.

During transmission, the wireless interface unit 106 performs digital-to-analog signal conversion, filtering, upconverting, and phase control on the symbol stream supplied from the signal processing unit 105 and generates a transmission signal. The transmission signal generated by the wireless interface unit 106 is supplied to the amplifying unit 107.

During reception, the wireless interface unit 106 performs down-conversion, filtering, and analog-to-digital signal conversion on a received signal supplied from the amplifying unit 107, and generates a symbol stream. The symbol stream generated by the wireless interface unit 106 is supplied to the signal processing unit 105.

The amplifying unit 107 amplifies a signal inputted from the wireless interface unit 106 or the antenna. A signal that is inputted from the wireless interface unit 106 during transmission and is amplified in the amplifying unit 107 is outputted to the antenna. A signal that is inputted from the antenna during reception and is amplified in the amplifying unit 107 is outputted to the wireless interface unit 106. In the example of FIG. 2, the antennas #1 to #4 are connected to the amplifying units 107-1 to 107-4, respectively.

Some of the amplifying units 107 may be provided as a configuration outside the communication unit 11. Alternatively, some of the amplifying units 107 may be included as the configurations of the wireless interface units 106.

The control unit 12 controls the communication unit 11 and the communication control unit 101. Some of the operations of the communication control unit 101 may be performed by the control unit 12. The communication control unit 101 and the control unit 12 may be configured as a single block.

The storage unit 13 holds information to be used by the communication unit 11 and control unit 12. Some of the operations of the communication storage unit 102 may be performed by the storage unit 13. The storage unit 13 and the communication storage unit 102 may be configured as a single block.

As described above, the individual data processing units 104, the signal processing units 105, the wireless interface units 106, the amplifying units 107, and the two antennas constitute a set. Two or more sets are provided as the constituent elements of the wireless communication device 1. Each of the sets is configured to implement wireless communications for each link.

Specifically, the set of the individual data processing unit 104-1, the signal processing unit 105-1, the wireless interface unit 106-1, the amplifying units 107-1 and 107-2, and the antennas #1 and #2 implements wireless communications of one link. Moreover, the set of the individual data processing unit 104-2, the signal processing unit 105-2, the wireless interface unit 106-2, the amplifying units 107-3 and 107-4, and the antennas #3 and #4 implements wireless communications of another link.

The storage unit may be included in the configuration that implements wireless communications of one link. The individual data processing units 104 and the signal processing units 105 may constitute a set, and two or more sets may be connected to one of the wireless interface units 106. The wireless interface units 106, the amplifying units 107, and the antennas may constitute a set, and two or more sets may be provided as the constituent elements of the wireless communication device 1. The communication unit 11 is implemented by at least one LSI.

The common data processing unit 103 is also referred to as an Upper MAC or a Higher MAC. The individual data processing unit 104 is also referred to as a Lower MAC.

A set of the individual data processing units 104 and the signal processing units 105 is also referred to as an AP entity or a Non-AP entity. The set of the individual data processing units 104 and the signal processing units 105 provided in the wireless communication device 1 operating as an AP MLD serves as an AP entity. The set of the individual data processing units 104 and the signal processing units 105 provided in the wireless communication device 1 operating as a Non-AP MLD serves as a Non-AP entity. The communication control unit 101 is also referred to as an MLD management entity.

### 2. First Embodiment, Operation Example of AP MLD

### <Operation Sequence of AP MLD>

The operation sequence of an AP MLD will be described as a first embodiment.

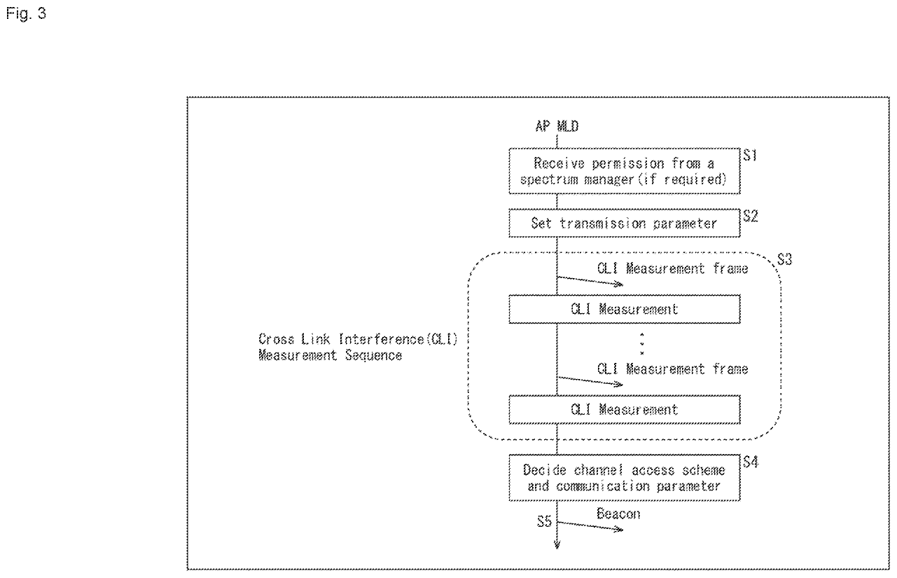

FIG. 3 is a sequence diagram for explaining the series of operations of the AP MLD.

In step S1, when requiring operation permission on a channel to operate and information about operation restrictions, the AP MLD receives the operation permission and the information on the operation restrictions from a Spectrum Manager. The Spectrum Manager is a communication device that provides a notification about the permission to operate and the operation restrictions. The information about the operation restrictions is information including operable channels and settable transmission power.

For example, the processing of step S1 is performed at, for example, a specified time after the AP MLD is turned on, after the AP MLD returns from a power-saving state, after a certain amount of movement of the AP MLD, or after the passage of a certain time following the last processing of step S1. When receiving the information about the operation restrictions, the AP MLD performs subsequent operations on the basis of the received information. If the processing is not necessary on a channel to operate, the AP MLD omits the processing of step S1.

Subsequently, in step S2, the AP MLD sets a communication parameter for measuring inter-link interference. The settings of the communication parameter include at least one of the settings of the transmission/reception channel of a signal for measuring inter-link interference, a frequency bandwidth, transmitting/receiving antennas, transmitted power, the kind of signal to be transmitted, and modulation encoding. The communication parameter may be set on the basis of the result of a measurement sequence of inter-link interference, the measurement sequence being performed in step S3.

Subsequently, in step S3, the AP MLD starts a Cross Link Interference (CLI) Measurement Sequence that is the measurement sequence of inter-link interference.

In the CLI Measurement Sequence, which will be specifically described later, the AP MLD transmits an inter-link interference measurement signal, which is a signal for measuring inter-link interference, on a certain channel on the basis of the communication parameter set in the processing of step S2.

Moreover, the AP MLD measures an inter-link interference amount on the basis of a signal received by an antenna for forming a link different from the link used for transmitting the inter-link interference measurement signal. As indicated by a broken line surrounding the CLI Measurement Sequence in FIG. 3, the transmission of the inter-link interference measurement signal and the measurement of inter-link interference are repeated in the sequence, so that an inter-link interference amount is measured between each of transmitting antennas and each of receiving antennas.

Thereafter, in step S4, the AP MLD sets a channel access scheme on the basis of the inter-link interference amount measured in the processing of step S3. Settings as the channel access scheme include, for example, whether to make an independent channel access for each link, whether to operate the AP MLD as a terminal capable of simultaneous transmission and reception, and whether to stop the operation of the AP entity. The detail of the channel access scheme will be described later. A communication parameter and the like are also set along with the channel access scheme.

In step S5, the AP MLD transmits, to a broadcast, a signal including information about inter-link interference, information about the setting contents of the channel access scheme, and information about the AP MLD. The signal to be transmitted to the broadcast may be a Beacon frame defined by IEEE 802.11.

### <CLI Measurement Sequence>

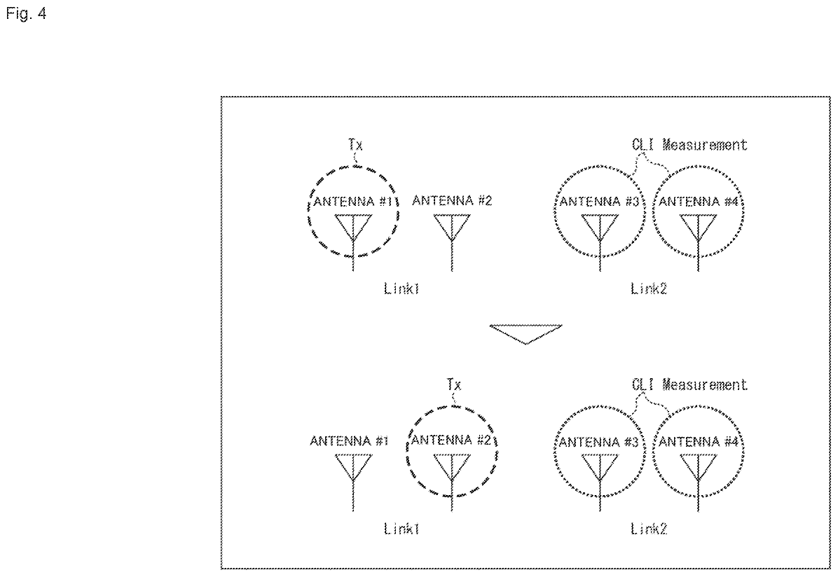

The CLI Measurement Sequence in the processing of step S3 will be specifically described below. The CLI Measurement Sequence is implemented by one of three sequences illustrated in FIGS. 4, 6, and 7.

FIGS. 4, 6, and 7 illustrate examples in which two antennas are used for each of two links Link 1 and Link 2. In other words, in the configurations of FIGS. 4, 6, and 7, 2×2 MIMO (Multiple Input Multiple Output) is used for each link. Although the main body of the AP MLD is not illustrated, the antennas illustrated in FIGS. 4, 6, and 7 are connected to the AP MLD.

FIGS. 4, 6, and 7 illustrate two links, each including two antennas. The number of links and the number of antennas in each link are not limited to two. Specifically, any number of links, for example, three or more links may be used in the AP MLD, and any number of antennas may be used in each of the links.

### ·First CLI Measurement Sequence

FIG. 4 illustrates a first CLI Measurement Sequence performed by the AP MLD.

First, as indicated by a circle of a broken line in the upper row of FIG. 4, the AP MLD transmits the inter-link interference measurement signal on a first channel by using the antenna #1 from among the antennas constituting Link 1.

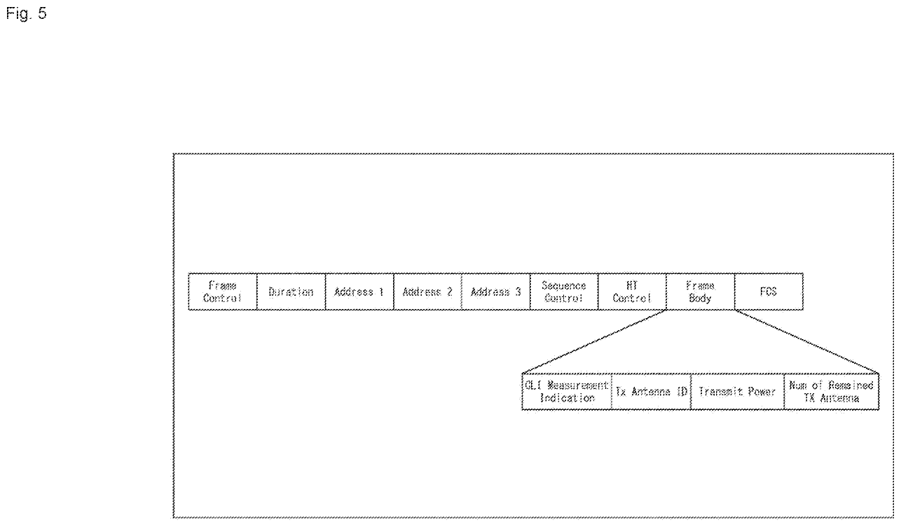

The inter-link interference measurement signal may be, for example, a signal only including a known symbol, a QoS NULL frame defined by IEEE 802.11, an NDP frame, or a Management frame. If the Management Frame is used, a frame with a Null Frame Body or a frame with a Frame Body including a Cross Link Interference Measurement Field indicated in FIG. 5 is transmitted.

FIG. 5 indicates a format example of a CLI measurement frame that is a Management Frame including a CLI Measurement Field in a Frame Body.

In FIG. 5, the CLI Measurement Frame includes the fields of Frame Control, Duration, Address 1, Address 2, Address 3, Sequence Control, HT Control, Frame Body, and FCS. The description of the same part as the conventional frame configuration will be omitted as appropriate.

In the field of Frame Body, at least one of CLI Measurement Indication, Tx Antenna ID, Transmit Power, and Num of Remained Tx Antenna is included as the CLI Measurement Field.

With this information, other wireless communication devices having received the CLI Measurement Frame can recognize that the CLI Measurement Frame is a signal for measuring inter-link interference. If the CLI Measurement Frame is recognized as a signal for measuring inter-link interference, other wireless communication devices can receive and demodulate the CLI Measurement Frame or continue other operations regardless of other CLI Measurement Frames transmitted after the received CLI Measurement Frame.

The CLI Measurement Indication includes information about the signal for measuring inter-link interference. The CLI Measurement Indication may include information about the CLI Measurement Sequence that is used as a method for measuring inter-link interference.

The Tx Antenna ID includes information about the identifier of the antenna used for transmitting a frame including the Tx Antenna ID.

The Transmit Power includes information about transmitted power that is used for transmitting a frame including the Transmit Power.

The Num of Remained Tx Antenna includes information about the number of antennas that are not used for transmitting the inter-link interference measurement signal.

In preparation for a difference between the timing of determination that the CLI Measurement Sequence is to be performed in the AP MLD and the timing of actual transmission after the setting of the channel access scheme or the like, a transmission parameter used for transmitting the inter-link interference measurement signal and the antenna may be directly associated with each other from the signal of the measurement result.

The inter-link interference measurement signal may be transmitted by using only some of the frequency bands of operating channels or a known sequence may be transmitted by using only some of the frequency bands. For example, such signals can be transmitted by using some frequency bands close to a channel for measuring inter-link interference.

The inter-link interference measurement signal may be an OFDM signal. In this case, the OFDM signal may be transmitted by using shorter Guard Interval than an ordinary transmission signal. The shortened Guard Interval is at least as long as Cyclic shift Delay. The inter-link interference measurement signal may be transmitted only when other surrounding terminals have a function to which the present technique is applied.

After the transmission of the inter-link interference measurement signal of, for example, the CLI Measurement Frame configured thus, as indicated by circles of dotted lines in the upper row of FIG. 4, the AP MLD measures inter-link interference on a second channel by using the antenna #3 and the antenna #4 that constitute Link 2 (inter-link interference is measured on the basis of signals received by the antenna #3 and the antenna #4), the inter-link interference being caused by the inter-link interference measurement signal transmitted from the antenna #1.

At this point, the AP MLD measures inter-link interference indicated as received signal strength by a Received Signal Strength Indicator (RSSI). The AP MLD may simultaneously or sequentially measure inter-link interference by using the antenna #3 and the antenna #4. If the measurement is not completed by one-time transmission of the inter-link interference measurement signal, the AP MLD may transmit the inter-link interference measurement signal again from the same antenna and measure inter-link interference by using the antenna where the measurement has not been completed.

As indicated by a circle of a broken line in the lower row of FIG. 4, the AP MLD transmits the inter-link interference measurement signal on the first channel by using the antenna #2 from among the antennas constituting Link 1.

As in the case where the antenna #1 is used for the transmission of the inter-link interference measurement signal, the AP MLD measures inter-link interference on the second channel by using the antenna #3 and the antenna #4 that constitute Link 2.

For example, if the symmetry of communication characteristics between the antennas belonging to the links is not ensured, the link for transmitting the inter-link interference measurement signal may be switched to another. Specifically, if symmetry is not ensured between the antenna #1 and the antenna #2 and the antenna #3 and the antenna #4 in FIG. 4, the AP MLD further transmits the inter-link interference measurement signal from the antenna #3 and the antenna #4 and measures inter-link interference on the basis of signals received by the antenna #1 and the antenna #2.

As described above, the first CLI Measurement Sequence is a sequence in which inter-link interference in the wireless communication device is measured by transmitting the inter-link interference measurement signal by using the antenna #1 of Link 1 of the wireless communication device, measuring inter-link interference by using the antennas #3 and #4 of Link 2, transmitting the inter-link interference measurement signal by using the antenna #2 of Link 1, and measuring inter-link interference by using the antennas #3 and #4 of Link 2.

The first CLI Measurement Sequence allows the AP MLD to obtain inter-link interference among the antennas #1 to #4.

### ·Second CLI Measurement Sequence

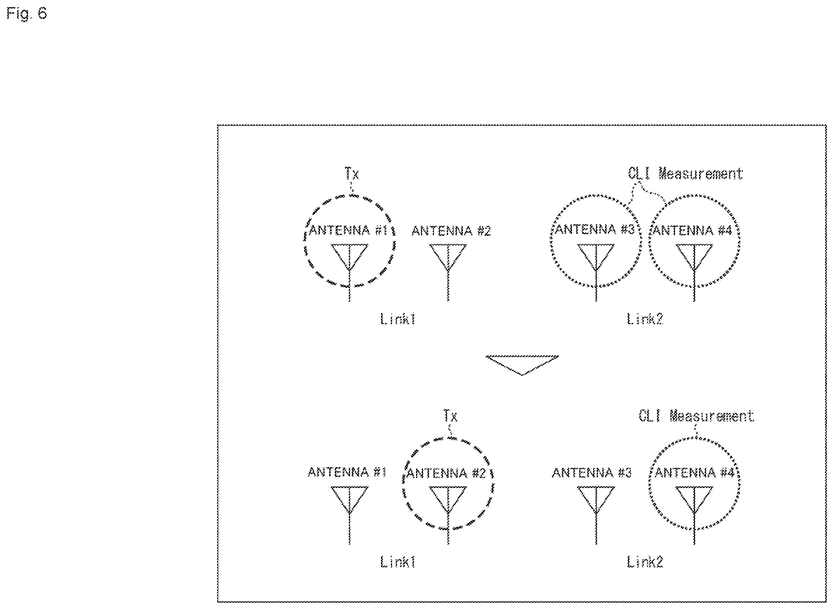

FIG. 6 illustrates a second CLI Measurement Sequence performed by the AP MLD.

First, as indicated by a circle of a broken line in the upper row of FIG. 6, the AP MLD transmits the inter-link interference measurement signal on the first channel by using the antenna #1 from among the antennas constituting Link 1. The inter-link interference measurement signal is identical to the signal used in the first CLI Measurement Sequence.

Subsequently, the AP MLD measures inter-link interference on the second channel by using the antenna #3 and the antenna #4 of Link 2, the inter-link interference being caused by the inter-link interference measurement signal transmitted from the antenna #1. The operation for measuring inter-link interference is identical to the operation in the first CLI Measurement Sequence.

The AP MLD compares an inter-link interference amount measured by using the antenna #3 and an inter-link interference amount measured by using the antenna #4. If it is determined that a difference between the two inter-link interference amounts compared with each other is smaller than a threshold value, the AP MLD sets one of the antenna #3 and the antenna #4 as a representative antenna. A plurality of representative antennas may be set.

As indicated by a circle of a broken line in the lower row of FIG. 6, the AP MLD transmits the inter-link interference measurement signal on the first channel by using the antenna #2 from among the antennas constituting Link 1. At this point, the inter-link interference measurement signal is identical to the signal used in the first CLI Measurement Sequence.

Subsequently, the AP MLD measures inter-link interference on the second channel by using the representative antenna of Link 2, the inter-link interference being caused by the inter-link interference measurement signal transmitted from the antenna #2. In the example of the lower row of FIG. 6, the antenna #4 is set as a representative antenna. The AP MLD handles an inter-link interference amount measured in the representative antenna, as an inter-link interference amount on the second channel in each of the antenna #3 and the antenna #4, and obtains an inter-link interference amount among the antennas #1 to #4.

Inter-link interference between all the antennas including the representative antenna may be obtained by correcting an inter-link interference amount measured in the representative antenna, on the basis of a difference between the inter-link interference amount measured in the antenna #3 and the inter-link interference amount measured in the antenna #4, the inter-link interference amounts being used for setting the representative antenna. For example, as the amount of interference with the antenna unselected as the representative antenna, the difference may be added to the inter-link interference measured in the representative antenna, so that the inter-link interference amount of the unselected antenna is obtained.

As described above, the second CLI Measurement Sequence is a sequence in which inter-link interference in the wireless communication device is measured by transmission using one of the antennas of Link 1, measuring inter-link interference by using the antennas #3 and #4 of Link 2, setting the antenna #4 of Link 2 as a representative antenna on the basis of the measurement result, transmitting the inter-link interference measurement signal by using the antenna #2 of the first link, and measuring interference by using the representative antenna.

### ·Third CLI Measurement Sequence

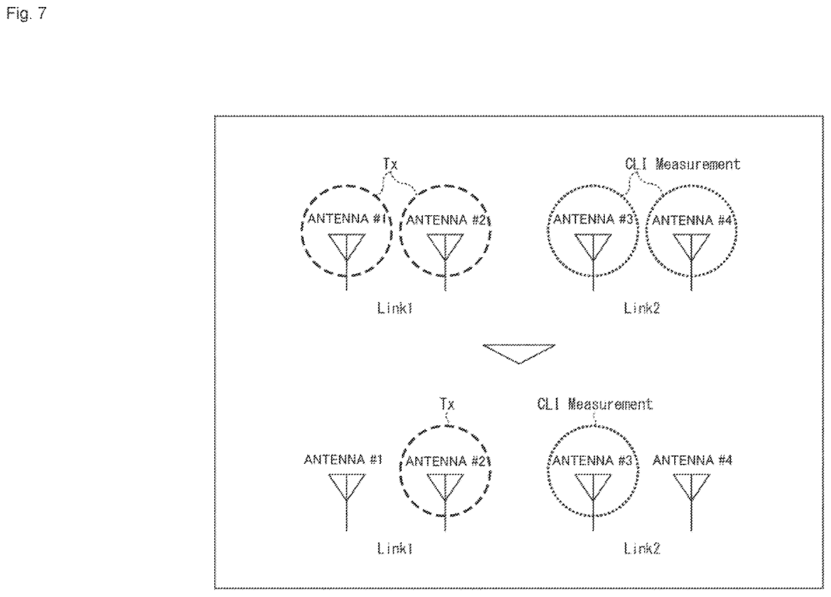

FIG. 7 illustrates a third CLI Measurement Sequence performed by the AP MLD.

First, as indicated in the upper row of FIG. 7, the AP MLD transmits the inter-link interference measurement signal on the first channel by using the antenna #1 and the antenna #2 that constitute Link 1. At this point, the inter-link interference measurement signal includes a known sequence orthogonal to each antenna. Moreover, the inter-link interference measurement signal may be a signal used for sounding of a known MIMO.

The AP MLD then measures inter-link interference, which is caused by the transmitted inter-link interference measurement signal, on the first channel by using the antenna #3 and the antenna #4 that constitute Link 2.

The AP MLD calculates a channel matrix on the basis of the transmitted inter-link interference measurement signal and the received inter-link interference measurement signal. The channel matrix is expressed by Formula (1) below.

$${Y}^{( {f}_{K} )} = {H}^{( {f}_{K} )} {X}^{( {f}_{K} )} \qquad ( 1 )$$

Variables in Formula (1) are expressed by Formulas (2) to (4) below. At this point, an A-th link is a link used for transmitting the inter-link interference measurement signal, and a B-th link is a link used for receiving the inter-link interference measurement signal.

$${Y}^{( {f}_{K} )} = [ \begin{matrix}{y}_{1}^{( {f}_{K} )} \\ ⋮ \\ {y}_{NB}^{( {f}_{K} )}\end{matrix} ] \qquad ( 2 )$$

$${H}^{( {f}_{K} )} = [ \begin{matrix}{h}_{11}^{( {f}_{K} )} & … & {h}_{1 Nm}^{( {f}_{K} )} \\ ⋮ & ⋮ & ⋮ \\ {h}_{Nn 1}^{( {f}_{K} )} & … & {h}_{NnNm}^{( {f}_{K} )}\end{matrix} ] \qquad ( 3 )$$

$${X}^{( {f}_{K} )} = \sqrt{\vert {p}_{L} \vert} [ \begin{matrix}{α}_{1}^{( {f}_{K} , {f}_{L} )} & & {X}_{1}^{( {f}_{L} )} \\ & ⋮ & \\ {α}_{Nm}^{( {f}_{K} , {f}_{L} )} & & {X}_{NA}^{( {f}_{L} )}\end{matrix} ] \qquad ( 4 )$$

In Formulas (2) to (4), N_{A} and N_{B} denote the number of antennas used in the A-th link and the number of antennas used in the B-th link, respectively, the antennas being used by the AP MLD. The A-th link and the B-th link correspond to Link 1 and Link 2, respectively.

The contents of parameters in Formulas (2) to (4) are expressed by given I, J, K, L as below. Some of the parameters included in Formulas (2) to (4) include superscripts/subscripts that are placed at different positions from those in the following description, but the same parameters are indicated.
x^{(fL)}_{J} indicates, on an L-th channel (having a center frequency at a frequency fL), a normalization transmission signal sequence that is observed by a J-th antenna of the A-th link.
α^{(fK,fL)}_{J} indicates, on the L-th channel, a complex amplitude ratio at which the transmission signal observed by the J-th antenna of the A-th link leaks to a K-th channel.
p_{L} indicates, on the K-th channel, transmitted power for each antenna of the A-th link.
y^{(fk)}_{I} indicates, on the K-th channel, a received signal sequence observed by an I-th antenna of the B-th link.
h^{(fk)}_{IJ} indicates, on the K-th channel, a transfer factor between the J-th antenna of the A-th link and the I-th antenna of the B-th link.

At this point, as x^{(fK)}_{J1} and x^{(fK)}_{J2} for different J₁ and J₂, an orthogonalization signal sequence and a known CSD may be used.

If the B-th link on the reception side is notified of the CLI Measurement frame in FIG. 5, a variable indicating the transmitting antenna in the formula and a transmission signal sequence for each transmitting antenna may be estimated on the basis of information included in Tx Antenna ID and Num of Remained Tx Antenna in the frame. Moreover, p_{L} may be estimated on the basis of information included in Transmit Power in the frame.

As indicated by a circle in the lower row of FIG. 7, the AP MLD sets a given antenna as a representative antenna in each link. In the example of FIG. 7, the antenna #2 is set as the representative antenna of Link 1 and the antenna #3 is set as the representative antenna of Link 2.

After setting the representative antenna, the AP MLD transmits the inter-link interference measurement signal on the second channel by using the antenna #2. At this point, the inter-link interference measurement signal is identical to the signal used in the first CLI Measurement Sequence.

The AP MLD measures the amount of interference, which is caused by the transmitted inter-link interference measurement signal, on the first channel by using the antenna #3.

Subsequently, the AP MLD estimates an out-of-band leakage ratio, which is a ratio of out-of-band leakage, on the basis of a known transmission signal sequence and a received signal.

As an example of a method of estimating an out-of-band leakage ratio, a Zero Forcing method (ZF method) is used in the following description. The method of estimating an out-of-band leakage power ratio is not limited to the ZF method. Other methods may be used instead.

If the ZF method is used, the signal transmitted by using the J-th antenna on the L-th channel leaks to the K-th channel with an out-of-band leakage power ratio α′^{(fK,fL)}_{J} that is expressed by Formula (5) below.

$${{α}_{J}^{′}}^{( {f}_{K} , {f}_{L} )} = Q \frac{{Y}^{( {f}_{L} )} {\{ {X}_{J}^{( {f}_{L} )} \}}^{H}}{\sqrt{\vert {p}_{K} \vert}} {γ}^{( {f}_{K} , {f}_{L} )} \qquad ( 5 )$$

At this point, {a}^{H} represents a complex transposed vector of a vector a. Q,Q′ represents a normalization coefficient.

Moreover, γ^{(fk,fL)} is expressed by Formula (6) below.

$${γ}^{( {f}_{K} , {f}_{L} )} = \vert {Q}^{′} \frac{{y}_{{N}_{B}}^{( {f}_{K} )} {\{ {x}_{{N}_{A}}^{( {f}_{L} )} \}}^{H}}{\sqrt{\vert {p}_{L} \vert}} \vert \qquad ( 6 )$$

γ^{(fK,fL)} indicates a leakage power ratio observed on the L-th channel by using an N_{B}-th antenna of the B-th link when the inter-link interference measurement signal is transmitted on the K-th channel by using an N_{A}-th antenna of the A-th link.

At this point, γ^{(fK,fL)} may be determined on the basis of an RSSI value observed by the NB-th antenna of the B-th link and information about transmitted power included in Transmit Power in the CLI Measurement Frame of FIG. 5, instead of Formula (6).

If noise power is observed, an out-of-band leakage power ratio may be estimated by a Minimize Maximum Square error method (MMSE method). In this case, the out-of-band leakage power ratio is expressed by Formula (7) below.

$$Out - of - band leakage power ration = {\vert {{α}_{J}^{′}}^{( {f}_{K} , {f}_{L} )} \vert}^{2} \qquad ( 7 )$$

At this point, Formular (7) indicates an out-of-band leakage power ratio at which the signal transmitted on the L-th channel by using the J-th antenna leaks to the K-th channel.

The third CLI Measurement Sequence also allows the AP MLD to obtain channel characteristics among the antennas #1 to #4. By using the third CLI Measurement Sequence, inter-link interference of any pairs of antennas, specifically, three or more pairs of antennas can be particularly measured by repeating the measurement sequence two times.

As described above, the third CLI Measurement Sequence is a sequence in which inter-link interference in the wireless communication device is measured by obtaining channel characteristics between the antennas by transmitting the inter-link interference measurement signal by using the antennas #1 and #2 of Link 1 on the first channel and measuring inter-link interference by using the antennas #3 and #4 of Link 2 on the first channel, and obtaining an out-of-band leakage power ratio by transmitting the inter-link interference measurement signal on the second channel from the antennas of Link 1 and measuring the inter-link interference measurement signal by using the antennas of Link 2 on the first channel.

### <Operation of Control Unit of AP MLD>

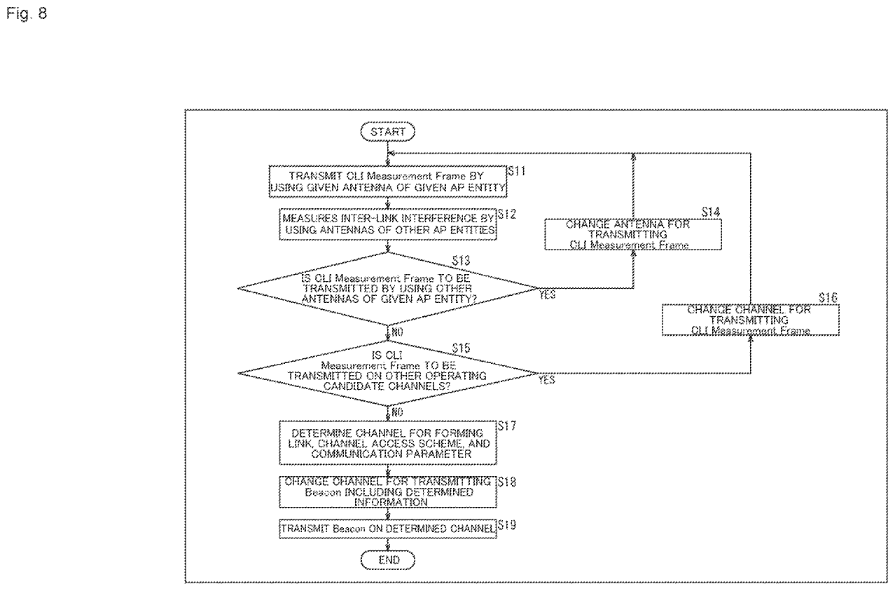

FIG. 8 is a flowchart showing the operations of the control unit 12 (FIG. 2) of the AP MLD according to the first embodiment.

In step S11, the control unit 12 transmits the CLI Measurement Frame by using a given antenna of a given AP entity. In the example described with reference to FIG. 4, the CLI Measurement Frame is transmitted by using the pair of the individual data processing unit 104-1 and the signal processing unit 105-1 as the given AP entity and using the antenna #1 as the given antenna from the antennas #1 and #2 connected to the given AP entity.

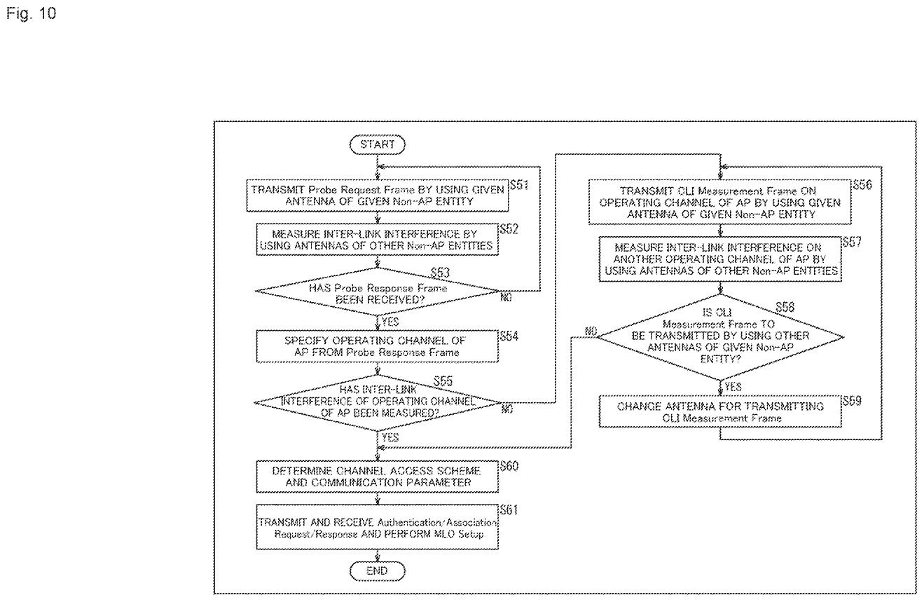

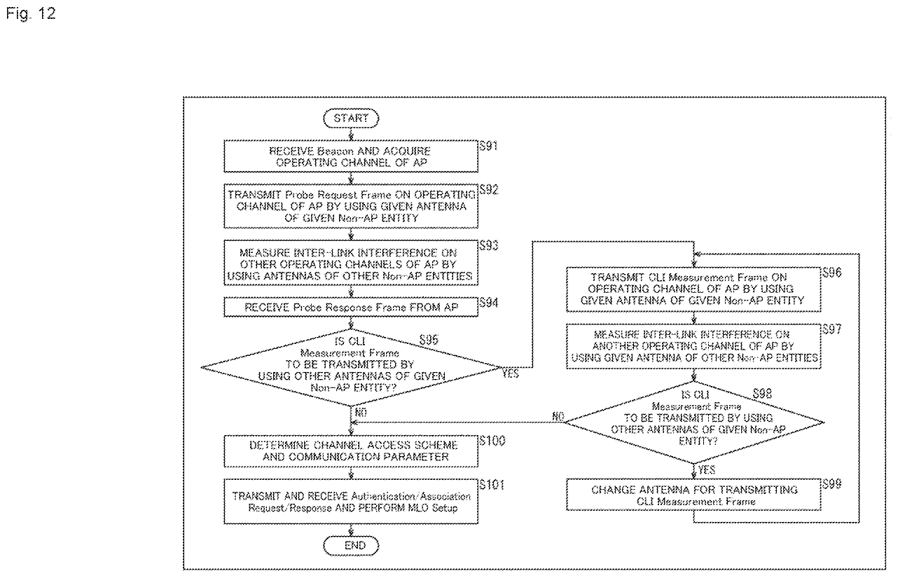

For example, a predetermined channel is selected from the candidates of operating channels and is used for transmitting the CLI Measurement Frame. The operating channel is a channel that can be used (operated) for communications by the AP MLD. The CLI Measurement Frame is used as the inter-link interference measurement signal in the following description. The same applies to FIGS. 10 and 12 to be described later.

In step S12, the control unit 12 measures inter-link interference, which is caused by the inter-link interference measurement signal transmitted in step S11, on the basis of the signals received by using the antennas of other AP entities.

In step S13, the control unit 12 determines whether to transmit the CLI Measurement Frame from other antennas connected to the given AP entity. If it is determined that the inter-link interference measurement signal is to be transmitted from other antennas in step S13, the processing advances to step S14.

In step S14, the control unit 12 changes the antenna to be used for transmitting the CLI Measurement Frame. Thereafter, the process returns to step S11, and the foregoing processing is repeated by using the changed antenna as the given antenna.

If it is determined that the CLI Measurement Frame is not to be transmitted from other antennas in step S13, in step S15, the control unit 12 determines whether to transmit the CLI Measurement Frame by using other operating candidate channels. If it is determined that the CLI Measurement Frame is to be transmitted by using other operating candidate channels in step S15, the process advances to step S16.

In step S16, the control unit 12 changes the channel for transmitting the CLI Measurement Frame. Thereafter, the process returns to step S11, and the foregoing processing is repeated by using the changed channel as a channel to be used for transmitting the CLI Measurement Frame.

If it is determined that the CLI Measurement Frame is not to be transmitted by using other operating candidate channels in step S16, in step S17, the control unit 12 sets a channel for forming a link, a channel access scheme, and a communication parameter.

In step S18, the control unit 12 determines a channel used for transmitting a Beacon including set information. The Beacon is a signal to be transmitted to a broadcast.

In step S19, the control unit 12 transmits the Beacon by using the determined channel.

As described above, the AP MLD can measure an interference amount between links to be formed by the AP MLD and make a proper communication setting on the basis of the measured inter-link interference amount. Furthermore, the AP MLD can make the communication setting before starting communications with the Non-AP MLD that is another wireless communication device.

### <Detail of Setting of Channel Access Scheme>

The setting of the channel access scheme performed by the AP MLD in step S4 of FIG. 3 will be specifically described below. As described above, in step S4 of FIG. 3, the channel access scheme or the like is set on the basis of an inter-link interference amount between each of the transmitting antennas and each of the receiving antennas, the inter-link interference amount being measured by the CLI Measurement Sequence.

L13 denotes an inter-link interference amount from the antenna #1 to the antenna #3, L23 denotes an inter-link interference amount from the antenna #2 to the antenna #3, L14 denotes an inter-link interference amount from the antenna #1 to the antenna #4, and L24 denotes an inter-link interference amount from the antenna #2 to the antenna #4.

### ·First Case

In a first case, all the antennas have an inter-link interference amount smaller than a first threshold value, and the sum of inter-link interference amounts from the same transmitting antenna to all the receiving antennas is smaller than the first threshold value. Specifically, L13, L14, L23, and L24 are all smaller than the threshold value and L13+L14 and L23+L24 are smaller than the threshold value in the first case.

In this case, the AP MLD sets the links such that each of the links independently makes channel access. Moreover, the AP MLD sets the AP MLD as a terminal capable of simultaneous transmission and reception, that is, a terminal capable of simultaneously transmitting and receiving data.

### ·Second Case

In a second case, at least one of the antennas has an inter-link interference amount equal to or larger than the first threshold value, and the sum of inter-link interference amounts from at least one of the transmitting antenna to all the receiving antennas is equal to or larger than the first threshold value. Specifically, at least one of L13, L14, L23, and L24 is equal to or larger than the threshold value and at least one of L13+L14 and L23+L24 is equal to or larger than the threshold value in the second case.

In this case, the AP MLD makes a setting that stops a smaller number of antennas in a comparison between the antennas receiving inter-link interference not smaller than a detected threshold value and the antennas causing inter-link interference not smaller than the detected threshold value, stops the operations of the AP entities of the links connected to the antennas, and allows the AP entities to independently make channel access, or makes a setting that allows the AP entities of the links to make a synchronous channel access without stopping the operations of the AP entities. Moreover, the AP MLD sets the AP MLD as a terminal incapable of simultaneous transmission and reception, that is, a terminal incapable of simultaneously transmitting and receiving data.

### ·Third Case

In a third case, all the antennas have an inter-link interference amount equal to or larger than the first threshold value, or the sum of inter-link interference amounts from the same transmitting antenna to all the receiving antennas is equal to or larger than the threshold value. Specifically, L13, L14, L23, and L24 are all equal to or larger than the threshold value or L13+L14 and L23 +L24 are all equal to or larger than the threshold value in the third case.

In this case, the AP MLD makes a setting that stops a smaller number of antennas in a comparison between the antennas receiving inter-link interference not smaller than a detected threshold value and the antennas causing inter-link interference not smaller than the detected threshold value, stops the operations of the AP entities connected to the antennas, and allows the AP entities to independently make channel access in each link, or makes a setting that allows the AP entities of the links to make a synchronous channel access without stopping the operations of the AP entities. Moreover, the AP MLD sets the AP MLD as a terminal incapable of simultaneous transmission and reception.

### 3. Second Embodiment, Operation Example of Non-AP MLD

The operations of a Non-AP MLD will be described as a second embodiment.

Operations for measuring inter-link interference by the Non-AP MLD include an operation for measuring interference by transmitting, from the Non-AP MLD, a signal for detecting an AP MLD to be connected, and an operation for measuring interference by receiving a signal from an AP MLD to the Non-AP MLD. Specifically, the operations correspond to Active Scan and Passive Scan that are defined by IEEE 802.11. The operations of Active Scan and Passive Scan will be sequentially described below.

The present embodiment eliminates the need for operation permission on a channel to operate by the Non-AP MLD and information about operation restrictions.

### 3-1. Operation Example of Non-AP MLD performing Active Scan

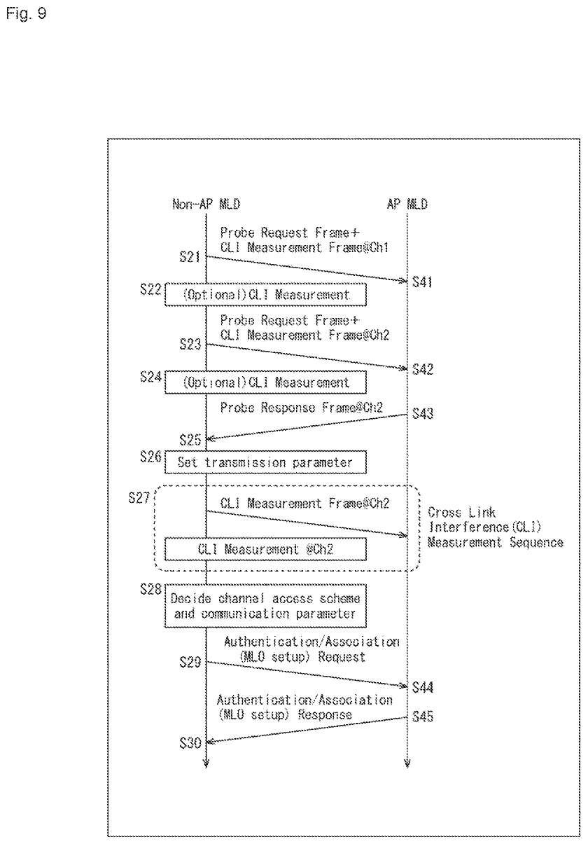

FIG. 9 is a sequence diagram for explaining the series of operations of Active Scan performed by the Non-AP MLD. In the operations of Active Scan, the signal for detecting the AP MLD to be connected is transmitted and inter-link interference is measured.

In step S21, the Non-AP MLD transmits a detection signal on a given channel. The detection signal is a signal for detecting the AP MLD. The detection signal may be a Probe Request Frame defined by IEEE 802.11. In the example of FIG. 9, a CLI Measurement Frame is transmitted with the Probe Request Frame on a first channel (Ch1).

For example, the processing of step S21 is performed, for example, after the Non-AP MLD is turned on or after the Non-AP MLD returns from a power-saving state.

In step S22, the Non-AP MLD sets a communication parameter for measuring inter-link interference and measures inter-link interference by using the detection signal transmitted in step S21. Inter-link interference may be measured by using the CLI Measurement Frame. The operation for measuring inter-link interference is identical to the operation described in the first embodiment. In this case, inter-link interference is measured as necessary.

In step S23, the Non-AP MLD changes a channel and retransmits the signal for detecting the AP MLD. In the example of FIG. 9, the CLI Measurement Frame is transmitted with the Probe Request Frame on a second channel (Ch2).

In step S24, the Non-AP MLD measures inter-link interference as in the processing of step S22. The foregoing processing is repeated until the Non-AP MLD receives a response signal from the AP MLD.

In steps S41 and S42, the AP MLD receives the Probe Request Frame transmitted from the Non-AP MLD. In the example of FIG. 9, the Probe Request Frame transmitted from the Non-AP MLD on the second channel is received as on the operating channel of the AP MLD.

In step S43, the AP MLD transmits a response signal on the second channel in response to the signal received in step S42. The response signal includes information about at least one of a combination of channels that can be operated by the AP MLD, a frequency bandwidth on each channel, transmitted power, and modulation encoding. The response signal may be the Probe Response Frame defined by IEEE 802.11.

In step S25, the Non-AP MLD receives the response signal transmitted from the AP MLD.

In step S26, the Non-AP MLD sets a communication parameter for measuring inter-link interference. The settings of the communication parameter include at least one of the settings of the transmission/reception channel of an inter-link interference measurement signal, a frequency bandwidth, transmitting/receiving antennas, transmitted power, the kind of signal to be transmitted, and modulation encoding. The Non-AP MLD may set the communication parameter on the basis of information included in the response signal received in step S25.

In step S27, the Non-AP MLD performs a CLI Measurement Sequence that is a measurement sequence of inter-link interference. The CLI Measurement Sequence is the same operation as the operation performed by the AP MLD in the first embodiment.

In the CLI Measurement Sequence of step S27, the Non-AP MLD transmits an inter-link interference measurement signal by using a link on the basis of the set communication parameter.

The Non-AP MLD measures inter-link interference on the basis of a signal received by an antenna for forming a link different from the link used for transmitting the inter-link interference measurement signal.

The inter-link interference measurement signal can be a Management Frame defined by IEEE 802.11. If the Management Frame is used, a frame with a Frame Body including a Cross Link Interference Measurement Field indicated in FIG. 5 is transmitted. The Non-AP MLD may transmit the frame with the Frame Body including information corresponding to the Probe Request Frame.

In the CLI Measurement Sequence, the transmission of the inter-link interference measurement signal and the measurement of inter-link interference are repeated, so that an inter-link interference amount is measured between each of transmitting antennas and each of receiving antennas.

In step S28, the Non-AP MLD sets a channel access scheme and a communication parameter on the basis of the inter-link interference amount measured in step S27.

In step S29, the Non-AP MLD transmits, to the AP MLD, a signal including information about measured inter-link interference, information about setting contents in step S28, and information about the Non-AP MLD. The signal used for transmitting the information may be an Authentication/Association Request Frame defined by IEEE 802.11.

In step S44, the AP MLD receives the Authentication/Association Request transmitted from the Non-AP MLD.

In step S45, the AP MLD transmits an Authentication/Association Response to the Non-AP MLD and sets a Multi-Link Operation (MLO).

In step S30, the Non-AP MLD receives the Authentication/Association Response transmitted as a response signal from the AP MLD and sets the MLO.

FIG. 10 is a flowchart showing an operation of the control unit 12 of the Non-AP MLD according to the second embodiment. Duplicate explanation will be omitted as appropriate.

In step S51, the control unit 12 transmits the Probe Request Frame by using a given antenna of a given Non-AP entity.

In step S52, the control unit 12 measures inter-link interference, which is caused by the signal transmitted in step S51, on the basis of signals received by using the antennas of other Non-AP entities.

In step S53, the control unit 12 determines whether the Probe Response Frame transmitted from the AP MLD has been received. If it is determined that the Probe Response Frame has not been received in step S53, the process returns to step S51, a channel for transmitting the Probe Request Frame is changed, and the foregoing processing is repeated.

If it is determined that the Probe Response Frame has been received in step S53, in step S54, the control unit 12 specifies the operating channel of the AP MLD on the basis of information included in the received Probe Response Frame.

In step S55, the control unit 12 determines whether the inter-link interference of the operating channel of the AP MLD has been measured, the operating channel being specified in step S54. If it is determined that the inter-link interference of the operating channel of the AP MLD has not been measured in step S55, the processing advances to step S56.

In step S56, the control unit 12 transmits the CLI Measurement Frame on the operating channel of the AP MLD by using a given antenna of a given Non-AP entity.

In step S57, the control unit 12 measures inter-link interference, which is caused by the CLI Measurement Frame transmitted in step S56, by using a given antenna of other Non-AP entities different from the Non-AP entity used for transmitting the CLI Measurement Frame.

In step S58, the control unit 12 determines whether to transmit the CLI Measurement Frame by using other antennas of the given Non-AP entity.

If it is determined that the CLI Measurement Frame is to be transmitted in step S58, in step S59, the control unit 12 changes the antenna for transmitting the CLI Measurement Frame. Thereafter, the process returns to step S56 and the foregoing processing is repeated.

If it is determined that the inter-link interference of the operating channel of the AP MLD has been measured in step S55 or if it is determined that the CLI Measurement Frame is not to be transmitted in step S58, the processing advances to step S60.

In step S60, the control unit 12 sets a channel access scheme and a communication parameter on the basis of the measured inter-link interference.

In step S61, the control unit 12 transmits an Authentication/Association Request to the AP MLD on the basis of the set communication parameter or the like. The control unit 12 receives an Authentication/Association Response transmitted from the AP MLD and performs MLO SETUP for establishing connection in the MLO.

As described above, the Non-AP MLD detects the AP MLD to be connected and measures inter-link interference according to the operating channel of the AP MLD, thereby making a proper communication setting on the basis of the measured inter-link interference amount.

### 3-2. Operation Example of Non-AP MLD Performing Passive Scan

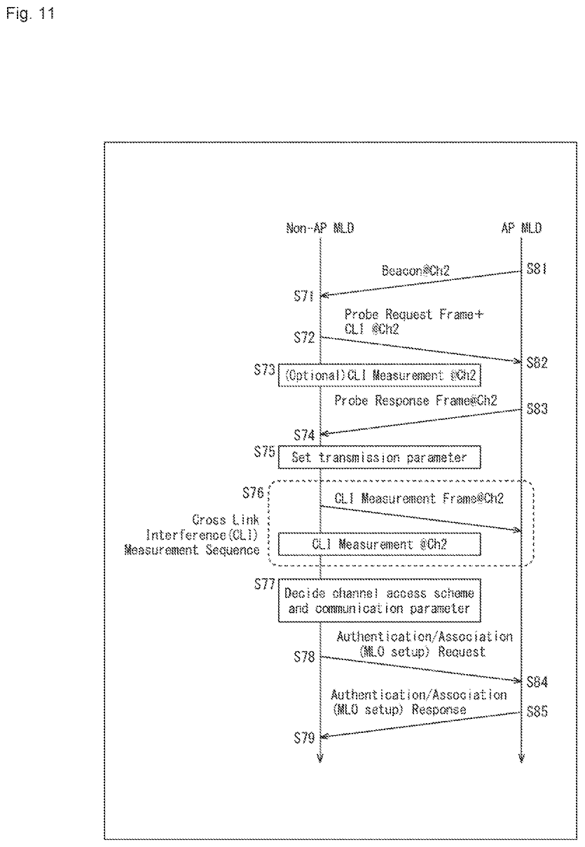

FIG. 11 is a sequence diagram for explaining the series of operations of Passive Scan performed by the Non-AP MLD. In the operations of Passive Scan, a signal from the AP MLD to be connected is received, and then inter-link interference is measured.

In step S81, the AP MLD transmits a periodic signal. The periodic signal is a periodically transmitted signal. At this point, the periodic signal may be a Beacon Frame defined by IEEE 802.11. In the example of FIG. 11, the Beacon Frame is transmitted on the second channel.

In step S71, the Non-AP MLD receives the periodic signal that is periodically transmitted from the AP MLD.

In step S72, the Non-AP MLD transmits the detection signal for detecting the AP MLD, to the AP MLD. The detection signal includes information about at least one of a combination of operable links, a frequency bandwidth on each channel, transmitted power, and modulation encoding. The detection signal may be the Probe Request Frame defined by IEEE 802.11.

In step S73, the Non-AP MLD measures inter-link interference by using the detection signal transmitted in step S72. Inter-link interference may be measured by using the CLI Measurement Frame. The operation for measuring inter-link interference is identical to the operation described in the first embodiment. In this case, inter-link interference is measured as necessary.

In step S82, the AP MLD receives the detection signal transmitted from the Non-AP MLD.

In step S83, the AP MLD transmits a response signal including information about channels operated or operable by the AP MLD, to the Non-AP MLD. The response signal may include information about at least one of a combination of channels, a frequency bandwidth on each channel, transmitted power, and modulation encoding. The response signal may be the Probe Response Frame defined by IEEE 802.11.

In step S74, the Non-AP MLD receives the response signal transmitted from the AP MLD.

The subsequent processing is the same as the processing described with reference to FIG. 9. Specifically, in the Non-AP MLD, the same processing as that of steps S26 to S30 in FIG. 9 is performed as the processing of steps S75 to S79. Moreover, in the AP MLD, the same processing as that of steps S44 and S45 in FIG. 9 is performed as the processing of steps S84 and S85.

In the AP MLD, the periodic signal transmitted in step S81 may include, as in the transmission in step S83, information about at least one of a combination of channels operated by the AP MLD and channels operable by the AP MLD, a frequency bandwidth on each channel, transmitted power, and modulation encoding.

If the periodic signal received in step S71 includes information about a combination of channels operated by the AP MLD and channels operable by the AP MLD, the Non-AP MLD may transmit the detection signal, which is transmitted in step S72, on the basis of information about the periodic signal. At this point, the Non-AP MLD may measure inter-link interference on the operating channel of the AP in step S73, and step S76 may be omitted.

FIG. 12 is a flowchart illustrating other operations of the control unit 12 of the Non-AP MLD according to the second embodiment. Duplicate explanation will be omitted as appropriate.

In step S91, the control unit 12 receives a Beacon that is a periodic signal transmitted from the AP MLD. The control unit 12 acquires the operating channel of the AP from the received periodic signal.

In step S92, the control unit 12 transmits the Probe Request Frame on the operating channel of the AP MLD by using a given antenna of a given Non-AP entity.

In step S93, the control unit 12 measures inter-link interference on other operating channels of the AP MLD by using the antennas of other Non-AP entities.

In step S94, the control unit 12 receives the Probe Response Frame transmitted from the AP MLD.

In step S95, the control unit 12 determines whether to transmit the CLI Measurement Frame by using other antennas of the given Non-AP entity. If it is determined that the CLI Measurement Frame is to be transmitted in step S95, the processing advances to step S96.

The subsequent processing is the same as the processing described with reference to FIG. 10. Specifically, in steps S96 to S101, the same processing as that of steps S56 to S61 of FIG. 10 is performed.

As described above, in the second embodiment, the Non-AP MLD measures an interference amount between links on the basis of information from the AP MLD to be connected, thereby making a proper communication setting on the basis of the measured inter-link interference amount.

### 4. Others

### <Effects of the Present Technique>

As described above, the AP MLD measures inter-link interference by using the antennas of each link on the operating candidate channels and sets the communication parameter and the channel access scheme. The Non-AP MLD measures inter-link interference by using the antennas of each link on the basis of information received from the AP MLD to be connected and sets the communication parameter and the channel access scheme.

Thus, the AP MLD and the Non-AP MLD can make proper communication settings in an MLO using an MIMO.

The effects described in the present specification are merely examples and are not intended as limiting, and other effects may be obtained.

The embodiments of the present technique are not limited to the foregoing embodiments, and various changes can be made without departing from the gist of the present technique.

### Combination Example of Configuration

The present technique can be configured as follows:
(1)
A wireless communication device including a control unit configured to cause an inter-link interference measurement signal to be transmitted by using a first channel from a first antenna or a second antenna that forms a first link from among a plurality of antennas of a communication unit that communicates with an external communication device through a plurality of links, and
measure interference caused by the inter-link interference measurement signal, by using a third antenna or a fourth antenna that forms a second link from among the plurality of antennas.
(2)
The wireless communication device according to (1), wherein
the control unit causes the inter-link interference measurement signal to be transmitted from the first antenna, and
measures inter-link interference on the second channel by using the third antenna and the fourth antenna.
(3)
The wireless communication device according to (2), wherein
the control unit causes another inter-link interference measurement signal to be transmitted from the second antenna unused for transmitting the inter-link interference measurement signal, and measures inter-link interference on the second channel by using the third antenna and the fourth antenna, the inter-link interference being caused by the other inter-link interference measurement signal.
(4)
The wireless communication device according to (2), wherein
the control unit sets one of the antennas forming the second link as a representative antenna on the basis of the measurement result of interference caused by the inter-link interference measurement signal,
causes another inter-link interference measurement signal to be transmitted from the second antenna, and
measures interference caused by the other inter-link interference measurement signal, by using the representative antenna.
(5)
The wireless communication device according to (1), wherein
the control unit causes the inter-link interference measurement signal to be transmitted from the first antenna and the second antenna, measures interference on the first channel by using the third antenna and the fourth antenna, the interference being caused by the inter-link interference measurement signal,
causes another inter-link interference measurement signal to be transmitted from the second antenna by using a second channel, and
performs the first measurement on interference caused by the other inter-link interference measurement signal, by using the third antenna.
(6)
The wireless communication device according to (1) to (5), wherein the control unit sets a channel access scheme on the basis of the measurement result of inter-link interference and establishes communications with the external communication device on the basis of the set channel access scheme.
(7)
The wireless communication device according to (6), wherein the control unit sets, as the channel access scheme, at least one of whether to make a channel access independently to the first link and the second link, whether to make a synchronous channel access to the links, and whether to stop the operations of the links.
(8)
The wireless communication device according to (1), wherein the control unit causes the inter-link interference measurement signal to be transmitted before communications with the external communication device are established.
(9)
The wireless communication device according to (1), wherein the control unit selects the first channel from a plurality of channels operable by the external communication device, on the basis of a signal received from the external communication device.
(10)
The wireless communication device according to (9), wherein the signal includes information about a channel operable by the external communication device.
(11)
The wireless communication device according to (1), wherein the inter-link interference measurement signal is a signal for detecting the external communication device, and a signal from the external communication device is a response signal to the signal for the detection.
(12)
The wireless communication device according to any one of (1) to (11), wherein the inter-link interference measurement signal is a signal including a known symbol.
(13)
The wireless communication device according to any one of (1) to (12), wherein the inter-link interference measurement signal is one of a QoS Null frame, an NDP frame, and a Management Frame that are defined by IEEE802.11.
(14)
The wireless communication device according to any one of (1) to (13), wherein the inter-link interference measurement signal includes at least one of information about a method of measuring inter-link interference, information about a transmitting antenna, information about transmitted power, and information about other antennas to transmit other inter-link interference measurement signals.
(15)
A wireless communication method by a wireless communication device, the method including: transmitting an inter-link interference measurement signal by using a predetermined channel from a first antenna or a second antenna that forms a first link from among a plurality of antennas of a communication unit that communicates with an external communication device through a plurality of links, and
measuring interference caused by the inter-link interference measurement signal, by using a third antenna or a fourth antenna that forms a second link from among the plurality of antennas.

### REFERENCE SIGNS LIST

1 Communication device
11 Communication unit
12 Control unit
13 Storage unit
101 Communication control unit
102 Communication storage unit
103 Common data processing unit
104-1, 104-2 Individual data processing unit
105-1, 105-2 Signal processing unit
106-1, 106-2 Wireless interface unit
107-1, 107-2, 107-3, 107-4 Amplifying unit
#1, #2, #3, #4 Antenna

1. A wireless communication device comprising a control unit configured to
cause an inter-link interference measurement signal to be transmitted by using a first channel from a first antenna or a second antenna that forms a first link from among a plurality of antennas of a communication unit that communicates with an external communication device through a plurality of links, and
measure interference caused by the inter-link interference measurement signal, by using a third antenna or a fourth antenna that forms a second link from among the plurality of antennas.

2. The wireless communication device according to claim 1, wherein
the control unit causes the inter-link interference measurement signal to be transmitted from the first antenna, and
measures inter-link interference on the second channel by using the third antenna and the fourth antenna.

3. The wireless communication device according to claim 2, wherein
the control unit causes another inter-link interference measurement signal to be transmitted from the second antenna unused for transmitting the inter-link interference measurement signal, and measures inter-link interference on the second channel by using the third antenna and the fourth antenna, the inter-link interference being caused by the other inter-link interference measurement signal.

4. The wireless communication device according to claim 2, wherein
the control unit sets one of the antennas forming the second link as a representative antenna on a basis of a measurement result of interference caused by the inter-link interference measurement signal,
causes another inter-link interference measurement signal to be transmitted from the second antenna, and
measures interference caused by the other inter-link interference measurement signal, by using the representative antenna.

5. The wireless communication device according to claim 1, wherein
the control unit causes the inter-link interference measurement signal to be transmitted from the first antenna and the second antenna, measures interference on the first channel by using the third antenna and the fourth antenna, the interference being caused by the inter-link interference measurement signal,
causes another inter-link interference measurement signal on a second channel to be transmitted from the second antenna, and
measures interference on the first channel by using the third antenna, the interference being caused by the other inter-link interference measurement signal.

6. The wireless communication device according to claim 1, wherein the control unit sets a channel access scheme on a basis of a measurement result of inter-link interference and establishes communications with the external communication device on a basis of the set channel access scheme.

7. The wireless communication device according to claim 6, wherein the control unit sets, as the channel access scheme, at least one of whether to make a channel access independently to the first link and the second link, whether to make a synchronous channel access to the links, and whether to stop operations of the links.

8. The wireless communication device according to claim 1, wherein the control unit causes the inter-link interference measurement signal to be transmitted before communications with the external communication device are established.

9. The wireless communication device according to claim 1, wherein the control unit selects the first channel from a plurality of channels operable by the external communication device, on a basis of a signal received from the external communication device.

10. The wireless communication device according to claim 9, wherein the signal includes information about a channel operable by the external communication device.

11. The wireless communication device according to claim 1, wherein
the inter-link interference measurement signal is a signal for detecting the external communication device, and
a signal from the external communication device is a response signal to the signal for the detection.

12. The wireless communication device according to claim 1, wherein the inter-link interference measurement signal is a signal including a known symbol.

13. The wireless communication device according to claim 1, wherein the inter-link interference measurement signal is one of a QoS Null frame, an NDP frame, and a Management Frame that are defined by IEEE802.11.

14. The wireless communication device according to claim 1, wherein the inter-link interference measurement signal includes information indicating that the inter-link interference measurement signal is a signal for measuring inter-link interference.

15. The wireless communication device according to claim 14, wherein the information indicating that the inter-link interference measurement signal is a signal for measuring inter-link interference includes at least one of information about a method of measuring inter-link interference, information about a transmitting antenna, information about transmitted power, and information about other antennas to transmit other inter-link interference measurement signals.

16. A wireless communication method by a wireless communication device, the method comprising:
transmitting an inter-link interference measurement signal by using a predetermined channel from a first antenna or a second antenna that forms a first link from among a plurality of antennas of a communication unit that communicates with an external communication device through a plurality of links; and
measuring interference caused by the inter-link interference measurement signal, by using a third antenna or a fourth antenna that forms a second link from among the plurality of antennas.
